(19) United States
(12) Patent Application Publication
(10) Pub. No.: US 2012/0216790 A1
(43) Pub. Date: Aug. 30, 2012

(54) UNIVERSAL SWING AWAY FOOD SUPPORTING RACK

(76) Inventor: WILLIAM LADON HOPKINS, Columbus, GA (US)

(21) Appl. No.: 13/407,594

(22) Filed: Feb. 28, 2012

Related U.S. Application Data
(60) Provisional application No. 61/447,534, filed on Feb. 28, 2011.

(51) Int. Cl. A47J 37/07

(52) U.S. Cl. 126/25 R

(57) ABSTRACT

A grill having an upper housing that is hingedly affixed to a lower housing. A universal fit upper grate assembly is provided that may be easily installed within an upper housing of grills of various sizes. The upper grate assembly is pivotally mounted to an inside surface of the upper housing. The upper grate assembly is made up of slidably interconnecting segments to facilitate an adjustable length of the upper grate assembly to accommodate different sized grills.

This application claims the priority of U.S. Provisional Patent Application No. 61/447,534 entitled “UNIVERSAL SWING AWAY FOOD SUPPORTING RACK,” filed Feb. 28, 2011, the contents of which are hereby incorporated by reference.

### FIELD OF THE INVENTION

The present invention relates generally to outdoor cooking grills, and more specifically to an adjustable food supporting grate installed in a lid of an outdoor cooking grill.

### BACKGROUND OF THE INVENTION

Gas-fired barbecue grills have experienced a tremendous growth in popularity since their introduction. Most gas-fired barbeque grills have a rectangular box-like structure with a hinged lid and a burner mounted in the bottom of the grill casting. The burner is connected to a gas supply line and is used to supply convective heat for cooking food as well as to heat lava rock, metal plates of various configuration, or wood product briquettes to supply some radiant heat and provide hot surfaces for grease vaporization. A grate is located above the rock or briquettes to provide a surface to support the food while it is being cooked. An additional upper grate mounted within the hinged lid is often provided and is made of a size and shape to match the particular hinged lid of the barbeque grill in question. There is a need to provide an additional upper grate that can fit a variety of sizes and types of upper hinged lids to match a wide range of barbeque grills with the same or “universal” part.

### SUMMARY OF THE INVENTION

The present invention describes a cooking grill cradle or food supporting rack having telescoping rods for adjusting the effective length for mounting on various sizes of grills. The food supporting rack of the present invention is considered “universal” because it fits most cooking grills.

### BRIEF DESCRIPTION OF THE DRAWINGS

FIG. 1 is a perspective view of a grill having an upper housing and a lower housing wherein the upper grate assembly of the invention is installed in the upper housing.

FIG. 2 is a perspective view of the upper grate assembly of FIG. 1.

FIG. 3 is a perspective exploded view of the upper grate assembly of FIG. 1.

FIG. 4 is a perspective view of the upper grate assembly and mounting hardware of FIG. 1.

FIG. 5A is a plan view of an outer grill member of the grill assembly of FIG. 1.

FIG. 5B is an end view of the outer grill member of the grill assembly of FIG. 5A.

FIG. 5C is a side view of the outer grill member of the grill assembly of FIG. 5A.

### DETAILED DESCRIPTION OF THE PREFERRED EMBODIMENTS

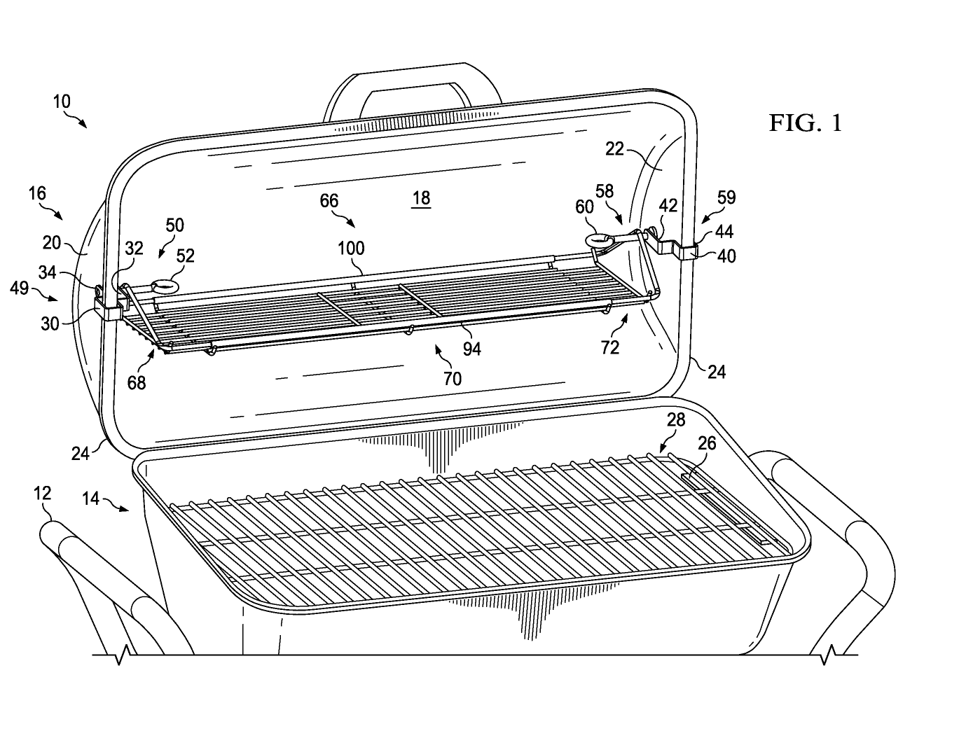

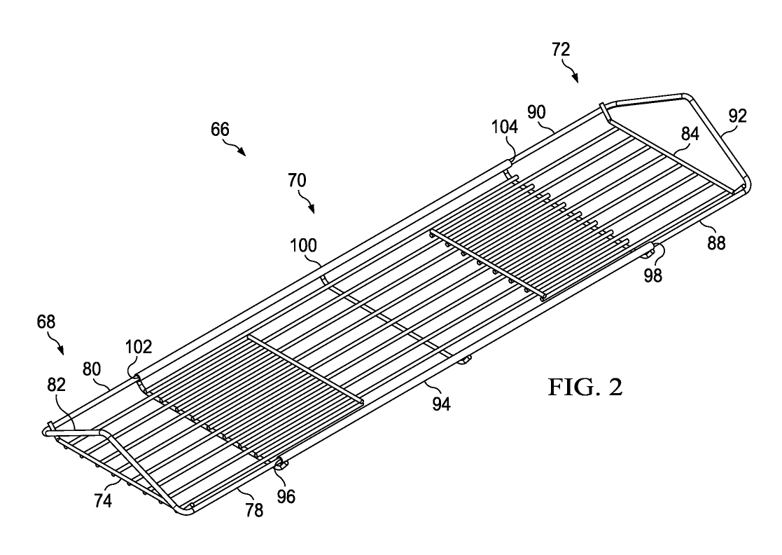

Referring first to FIG. 1, shown is a grill designated generally 10. Grill 10 has a stand 12 that supports a cooking enclosure that is made up of a lower housing 14 and an upper housing 16. Upper housing 16 is hingedly affixed to lower housing 14. Upper housing 16 has a top portion 18, first sidewall 20, and second sidewall 22. Upper housing 16 preferably has an outwardly protruding lip 24 that extends around the bottom edge of upper housing 16.

A grate support 26 is provided within lower housing 14. Grate member 28 is supported by grate support 26.

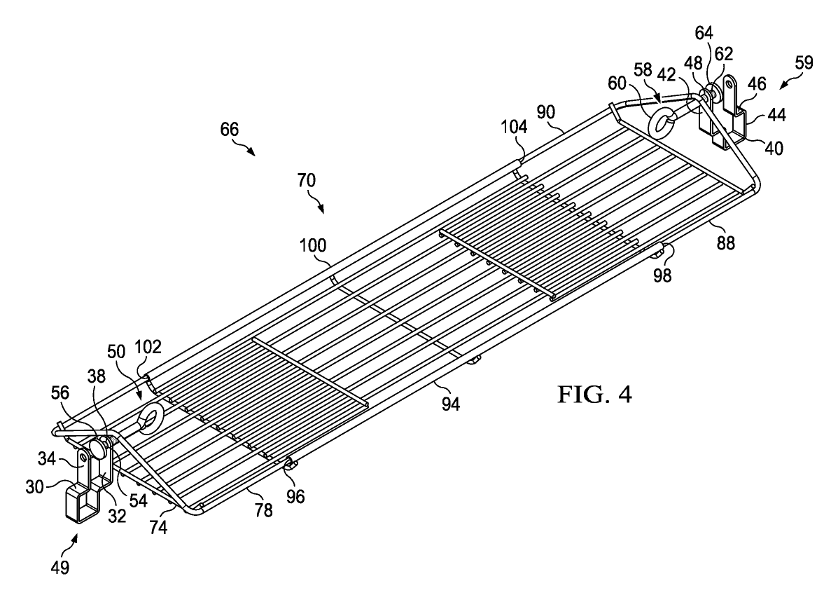

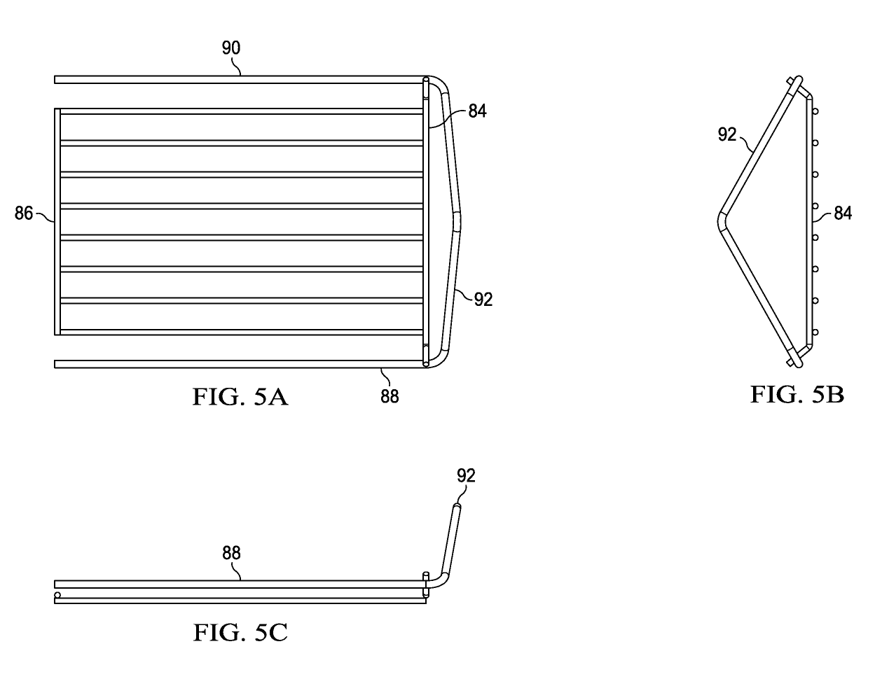

First bracket 30 (FIGS. 1 and 4) is removably affixed to first side wall 20 of upper housing 16. First bracket 30 has an inner leg 32 and outer leg 34. Outer leg 34 has an outer step 36 for resting on an upper surface of outwardly protruding lip 24 of upper housing 16. Inner leg 32 preferably defines threaded orifice 38 proximate an upper end. Second bracket 40 (FIGS. 1 and 4) is removably affixed to second side wall 22 of upper housing 16. Second bracket 40 has an inner leg 42 and an outer leg 44. Outer leg 44 has an outer step 46 for resting on upper surface of outwardly protruding lip 24 of upper housing 16. Inner leg 42 preferably defines threaded orifice 48 proximate an upper end.

A first securement member 50 engages a first bracket 30 for affixing first bracket 30 to upper housing 16 to form first bracket assembly 49. In one embodiment, first securement member 50 is a first I-bolt having an enclosed end 52 and a threaded end 54. First base member 56 is attached on threaded end 54 of first I-bolt 50. First I-bolt 50 is received within threaded orifice 38 of first bracket 30 for forcing first base member 56 to engage with first sidewall 20 of upper housing 16 for securing first bracket 30 within upper housing 16.

A second securement member 58 engages second bracket 40 for affixing second bracket 40 to upper housing 16 to form second bracket assembly 59. In one embodiment, second securement member 58 is a second I-bolt 58 having an enclosed end 60 and threaded end 62. Second base member 64 is attached on threaded end 62 of second I-bolt 58. Second I-bolt 58 is received within threaded orifice 48 of second bracket 40 for forcing second base member 64 into engagement with second sidewall 22 of upper housing 16 for securing second bracket 40 within upper housing 16. Although I-bolts 50 and 58 are shown as examples, it should be understood that other securing devices could also be used in association with brackets 30 and 40.

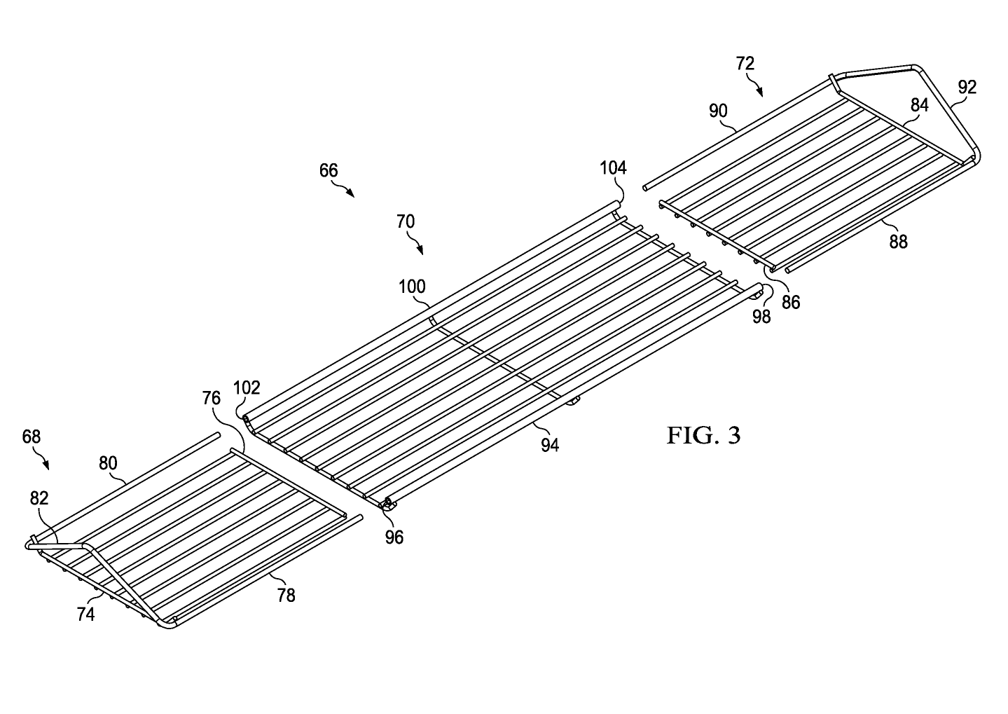

As best seen in FIG. 3, upper grate assembly 66 includes upper grate first end section 68, upper grate center section 70, and upper grate second end section 72. Upper grate end section 68 has an outer end 74, an inner end 76, and a front protuberance 78 extending towards inner end 76. Upper grate first end section 68 additionally has a rear protuberance 80 that extends towards inner end 76. First hanger 82 is affixed proximate to outer end 74 of upper grate first end section 68.

Upper grate second end section 72 has an outer end 84 and an inner end 86. A front protuberance 88 extends towards inner end 86. Rear protuberance 90 extends towards inner end 86. A second hanger 92 is affixed proximate to outer end 84 of upper grate second end section 72.

Upper grate center section 70 has a front tube member 94 having a first end 96 for slidably receiving front protuberance 78 of upper grate first end section 68. Front tube member 94 has a second end 98 for slidably receiving front protuberance 88 of upper grate second end section 72. Upper grate center section 70 also has a rear tube member 100 having a first end 102 for slidably receiving rear protuberance 80 of upper grate first end section 68. Rear tube member 100 also has a second end 104 for slidably receiving rear protuberance 90 of upper grate second end section 72. A slidable engagement of protuberances 78, 80, 88, and 90 within front tube member 94 and rear tube member 100 allows for a length of upper grate assembly 66 to be adjustable to fit within an existing upper housing 16 of various sizes. For purposes of example, the figures show tube members 94 and 100 affixed to a center section 70 for receiving protuberances 78, 80, 88, and 90. However, the arrangement of tubes and protuberances could be reversed, i.e., protuberances could be located on center section 70 and tubes located on end sections 68 and 72, or any combination of locations of mating tubes and protuberances or other slidably engageable members.

First hanger 82 of upper grate first end section 68 is configured to engage first I-bolt 50 and second hanger 92 of upper grate second end section 72 is configured for engagement with second I-bolt 58 to facilitate suspension of upper grate assembly 66 from upper housing 16 of grill body 10.

In a preferred embodiment, hangers 82, 92 are pivotally engaged with I-bolts 50, 58 so that upper grate assembly 66 is free to swing to maintain a substantially horizontal orientation when upper housing 16 is pivoted to an upper open position or to a lower closed position.

Thus, the present invention is well adapted to carry out the objectives and attain the ends and advantages mentioned above as well as those inherent therein. While presently preferred embodiments have been described for purposes of this disclosure, numerous changes and modifications will be apparent to those of ordinary skill in the art. Such changes and modifications are encompassed within the spirit of this invention as defined by the claims.

What is claimed is:

1. A grill comprising:
a lower housing;
an upper housing hingedly affixed to said lower housing;
an upper grate assembly pivotally mounted to an inside surface of said upper housing, said upper grate assembly having slidably interconnecting segments including a first end section and a second end section.

2. The grill according to claim 1 further comprising:
a first bracket assembly removably affixed to a first sidewall of said upper housing, said first bracket assembly having an inner leg.

3. The grill according to claim 2 wherein:
said inner leg of said first bracket assembly defines an orifice.

4. The grill according to claim 3 wherein:
said first bracket assembly includes a securement member having a first end and a second end, said second end received within said orifice;
a first base member received on said second end;
wherein said first base member engages said inside surface of said upper housing for securing said first bracket within said upper housing.

5. The grill according to clam 2 further comprising:
a hanger affixed to said upper grate assembly;
said hanger engaging said first bracket assembly.

6. The grill according to claim 2 further comprising:
said upper housing having a top portion, a first side wall, a second side wall, and a bottom edge, said upper housing having a lip extending outwardly adjacent to said bottom edge;
said first bracket assembly removably affixed to said inside surface of said upper housing, said first bracket assembly having an inner leg and an outer leg, said outer leg having an outer step for resting on an upper surface of said lip of said upper housing.

7. The grill according to claim 1 wherein:
said slidably interconnecting segments of said upper grate assembly comprise said first end section, a center section and said second end section.

8. The grill according to claim 7 wherein:
said first end section of said upper grate assembly has an outer end, an inner end, a front protuberance extending from said inner end and a rear protuberance extending from said inner end.

9. The grill according to claim 8 wherein:
said second end section of said upper grate assembly has an outer end, an inner end, a front protuberance extending from said inner end and a rear protuberance extending from said inner end; and
said center section of said upper grate assembly has a front tube member having a first end for slidably receiving said front protuberance of said first end section, said front tube member having a second end for slidably receiving said front protuberance of said second end section, said center section having a rear tube member having a first end for slidably receiving said rear protuberance of said first end section, said rear tube member having a second end for slidably receiving said rear protuberance of said second end section of said upper grate assembly, for allowing a length of said upper grate assembly to be adjustable.

10. The grill according to claim 2 further comprising:
a first hanger affixed to said first end section of said upper grate assembly engages said first bracket assembly to facilitate suspension of said upper grate assembly from said upper housing.

11. A grill comprising:
a lower housing;
an upper housing hingedly affixed to said lower housing, said upper housing having a top portion, a first side wall, a second side wall, and a bottom edge;
a first bracket assembly having an inner leg adjacent said first side wall and a first securement member for removably affixing said first bracket assembly to said first side wall of said upper housing; and
an upper grate assembly movably affixed to said first bracket assembly for being suspended therefrom.

12. The grill according to claim 11 wherein:
said inner leg of said first bracket assembly defines a threaded orifice;
said first securement member is a threaded member having a first end and a threaded end, said threaded end received within said threaded orifice;
a first base member received on said threaded end of said threaded member;
wherein said first securement member is rotatable within said threaded orifice of said inner leg for forcing said first base member into engagement with said first side wall of said upper housing for securing said first bracket assembly within said upper housing.

13. The grill according to claim 11 wherein:
said upper housing has a lip extending outwardly adjacent said bottom edge;
said first bracket assembly has an outer leg, said outer leg having an outer step for resting on an upper surface of said lip of said upper housing.

14. The grill according to claim 11 wherein:
said upper grate assembly is comprised of a first end section, a center section and a second end section;
said first end section having an outer end, an inner end, a front protuberance extending from said inner end and a rear protuberance extending from said inner end;
said second end section having an outer end, an inner end, a front protuberance extending from said inner end and a rear protuberance extending from said inner end;
said center section having a front tube member having a first end for slidably receiving said front protuberance of said first end section, said front tube member having a second end for slidably receiving said front protuberance of said second end section, said center section having a rear tube member having a first end for slidably receiving said rear protuberance of said first end section, said rear tube member having a second end for slidably receiving said rear protuberance of said second end section, for allowing a length of said upper grate assembly to be adjustable.

15. The grill according to claim 14 further comprising:
a first hanger assembly affixed proximate to said outer end of said first end section of said upper grate assembly.

16. The grill according to claim 15:
wherein said first hanger of said first end section of said upper grate assembly engages said first hanger assembly for facilitating suspension of said upper grate assembly from said upper housing.
